(19) United States
(12) Patent Application Publication
(10) Pub. No.: US 2021/0125340 A1
(43) Pub. Date: Apr. 29, 2021

(54) VIBRATION ANALYSIS DEVICE, CONTROL METHOD FOR VIBRATION ANALYSIS DEVICE, AND NON-TRANSITORY COMPUTER-READABLE RECORDING MEDIUM

(71) Applicant: SHARP KABUSHIKI KAISHA, Sakai City, Osaka (JP)

(72) Inventors: KEISUKE OMORI, Sakai City, Osaka (JP); KEI TOKUI, Sakai City, Osaka (JP)

(21) Appl. No.: 17/046,770

(22) PCT Filed: Mar. 28, 2019
(86) PCT No.: PCT/JP2019/013665

§ 371 Date: Oct. 10, 2020

(30) Foreign Application Priority Data
Apr. 10, 2018 (JP) 2018-075567

(51) Int. Cl. G06T 7/20; G06T 11/00

(52) U.S. Cl. CPC G06T 7/20; G06T 2207/10016; G06T 11/00

(57) ABSTRACT

A vibration analysis device includes an analysis axis configuration unit configured to configure analysis axes in accordance with an operation of a user; a vibration analyzing unit configured to analyze, based on a video of an object, vibration along each of the analysis axes of the object; and an output unit configured to output an analysis result obtained by the vibration analyzing unit.

### TECHNICAL FIELD

The present invention relates to a vibration analysis device, a control method for a vibration analysis device, a vibration analysis program, and a recording medium.

The present application claims priority to Japanese Patent Application 2018-075567 filed in Japan on Apr. 10, 2018, of which contents are incorporated herein by reference.

### BACKGROUND ART

Techniques for analyzing vibration of an object include a technique of placing a sensor, such as an acceleration sensor, on the object and analyzing the vibration of the object based on vibration information output by the sensor, a technique of irradiating the object with a laser beam and analyzing the object based on information of reflected light reflected by the object, and a technique of analyzing a moving image (video) of the object imaged by an imaging device. The technique of analyzing a video is useful in that measurement can be made remotely and a plurality of locations within the object can be analyzed.

As a technique for analyzing vibration of an object such as that described above, for example, PTL 1 discloses a technique of performing vibration analysis of a measurement object portion of a vibration measuring object based on images of the measurement object portion imaged in time series.

### CITATION LIST

### Patent Literature

PTL 1: JP 2003-156389 A (published May 30, 2003)

### SUMMARY OF INVENTION

### Technical Problem

Nevertheless, the technique described in PTL 1 cannot always suitably analyze the vibration of an object.

The present invention has been made in view of the problems described above, and an object of the present invention is to provide a vibration analysis device capable of suitably analyzing vibration of an object, and techniques related thereto.

### Solution to Problem

In order to solve the problems described above, a vibration analysis device according to an aspect of the present invention includes an analysis axis configuration unit configured to configure analysis axes in accordance with an operation of a user, a vibration analyzing unit configured to analyze, based on a video of an object, vibration along each of the analysis axes of the object, and an output unit configured to output an analysis result obtained by the vibration analyzing unit.

A vibration analysis device according to an aspect of the present invention includes an analysis axis configuration unit configured to configure analysis axes, a vibration analyzing unit configured to analyze, based on a video of an object, vibration along each of the analysis axes of the object, and a display unit configured to display the analysis axes superimposed onto an image of the object and display an analysis result by the vibration analyzing unit.

A control method for a vibration analysis device according to an aspect of the present invention is a control method for a vibration analysis device configured to analyze vibration of an object, the control method including an analysis axis configuration step of configuring analysis axes in accordance with an operation of a user, a vibration analyzing step of analyzing, based on a video of the object, the vibration along each of the analysis axes of the object, and an output step of outputting an analysis result of the vibration analyzing step.

### Advantage Effects of Invention

According to an aspect of the present invention, it is possible to provide a vibration analysis device capable of suitably analyzing vibration of an object, and techniques related thereto.

### BRIEF DESCRIPTION OF DRAWINGS

FIG. 1 is a functional block diagram illustrating a configuration of a vibration analysis system according to a first embodiment.

FIG. 2 is a flowchart illustrating an example of flow of a control process of a vibration analysis device according to the first embodiment.

FIG. 3 is a drawing illustrating a video of an object.

FIG. 4 is a drawing illustrating an example of an analysis result of vibration obtained by the vibration analysis device according to the first embodiment.

FIG. 5 is a drawing for explaining an example of configuring analysis axes in directions other than those of a Y-axis and an X-axis.

FIG. 6 is a drawing illustrating an example of an analysis result of vibration in a case where the analysis axes are configured in directions other than those of the Y-axis and the X-axis.

FIG. 7 is a drawing illustrating an example of an analysis result of vibration obtained by the vibration analysis device according to the first embodiment.

FIG. 8 is a drawing illustrating an example of an analysis result of vibration in a case where the analysis axes are changed to directions other than those of the Y-axis and the X-axis.

FIG. 9 is a drawing illustrating an example of an analysis result of vibration obtained by the vibration analysis device according to the first embodiment.

FIG. 10 is a graph showing a relationship between frequency and intensity of the vibration illustrated in FIG. 9.

FIG. 11 is a drawing illustrating an example of an analysis result of vibration analyzed on a per frequency basis.

FIG. 12 is a drawing for explaining a case where a direction of an analysis axis is changed from an X-axis direction to a direction between the X-axis direction and a Y-axis direction.

FIG. 13 is a drawing illustrating an example of a video of an object.

FIG. 14 is a drawing illustrating an example of a positional relationship between an imaging unit and an object.

FIG. 15 is a drawing illustrating an example of a video of an object.

FIG. 16 is a drawing illustrating an example of a video of an object.

FIG. 17 is a drawing illustrating an example of a video of an object.

FIG. 18 is a drawing illustrating an example of a video of an object.

FIG. 19 is a drawing illustrating an example of an image displayed on a display unit.

FIG. 20 is a drawing illustrating an example of an image displayed on a display unit.

### DESCRIPTION OF EMBODIMENTS

### First Embodiment

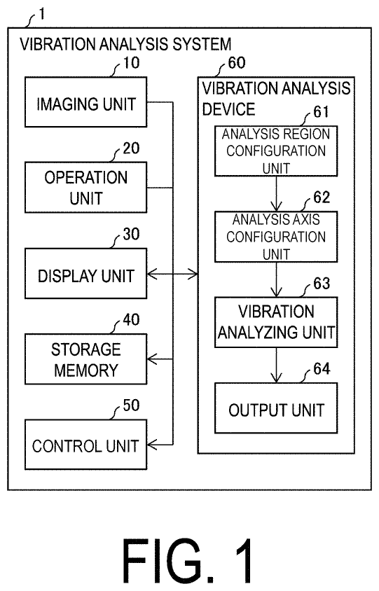

Below, a vibration analysis system 1, a vibration analysis device 60, and a control method for the vibration analysis device 60 according to an embodiment (first embodiment) of the present invention will be described in detail with reference to FIGS. 1 to 12.

### Vibration Analysis System 1

First, an example of a configuration of the vibration analysis system 1 according to an embodiment of the present invention will be described with reference to FIG. 1. FIG. 1 is a functional block diagram illustrating the configuration of the vibration analysis system 1 according to the first embodiment. As illustrated in FIG. 1, the vibration analysis system 1 includes an imaging unit 10, an operation unit 20, a display unit 30, a storage memory 40, a control unit 50, and the vibration analysis device 60. Further, in FIG. 1, the vibration analysis device 60 is connected to the imaging unit 10, the operation unit 20, the display unit 30, the storage memory 40, and the control unit 50.

### Imaging Unit 10

The imaging unit 10 captures a video of an object, and transmits the video of the object thus captured (video including the vibrating object, which is the object to be analyzed) as an input video to the vibration analysis device 60.

Here, in order to suitably capture the video of the object, the imaging unit 10 is preferably fixed. However, in a case where the object is a bridge or the like and is at a blind spot from the imaging unit 10 fixed to the ground during imaging, and in a case where imaging is difficult with the imaging unit 10 in a fixed state, the imaging unit 10 may be provided on a flying device (driving device) such as a drone, and moved together with the flying device. Even in a case where a video of the object is imaged while the imaging unit 10 is thus moved, the object is analyzed based on a displacement amount of an analysis region of the object relative to a non-moving point in the background on the input video, making it possible to suitably analyze vibration of the object.

### Operation Unit 20

The operation unit 20 receives input of an operation by a user, and is realized by, for example, a touch panel or a mouse. In a case where the operation unit 20 is a touch panel and the user inputs an input video via the touch panel, the input video is displayed on the display unit 30 provided with the touch panel.

### Display Unit 30

The display unit 30 displays various images. The display unit 30 displays, for example, a video of the object imaged by the imaging unit 10 and an analysis result by a vibration analyzing unit 63 output by an output unit 64. Note that, in the example described above, the display unit 30 is provided in the vibration analysis system 1 external to the vibration analysis device 60, but the vibration analysis device 60 may include the display unit 30. In this case as well, similar to the example described above, the analysis result obtained by the vibration analyzing unit 63 can be displayed.

### Storage Memory 40

The storage memory 40 stores, for example, various control programs and the like to be executed by the control unit 50. Examples of the storage memory 40 include a hard disk drive and nonvolatile storage devices such as a flash memory. The storage memory 40 stores, for example, an input video, an output video, an analysis region of the object, analysis axes, and an analysis result.

### Control Unit 50

The control unit 50 is configured to comprehensively control each functional block such as the imaging unit 10, the operation unit 20, the display unit 30, the storage memory 40, and the vibration analysis device 60.

### Vibration Analysis Device 60

The vibration analysis device 60 analyzes the vibration of the object in the input video, and outputs an analysis result. Here, a case where the input video is a video captured by the imaging unit 10 is described, but the video may be a video stored in the storage memory 40, a video obtained via a network, or a video stored in a removable storage device. Further, the vibration analysis device 60 is constituted by software or hardware such as a central processing unit (CPU), a graphics processing unit (GPU), a field-programmable gate array (FPGA), and an application-specific integrated circuit (ASIC), and may be operated by the same device as the control unit 50 or the like. As illustrated in FIG. 1, the vibration analysis device 60 includes an analysis region configuration unit 61, an analysis axis configuration unit 62, the vibration analyzing unit 63, and the output unit 64.

### Analysis Region Configuration Unit 61

The analysis region configuration unit 61 configures an analysis region to be analyzed for vibration, which is, of the input video input to the vibration analysis device 60, a region of at least a portion of the vibrating object. The analysis region configuration unit 61 can configure, as the analysis region, one or a plurality of points (pixels) on the object, a line such as an edge of the vibrating object, a region of a portion of the object, or a region of the entire object (all pixels), for example.

In one aspect, the analysis region configuration unit 61 configures the analysis region in accordance with a video of the object. In this case, the analysis region configuration unit 61 may detect a vibrating area from within the input video, and configure a point, a line, and a region on the detected object as the analysis region.

Further, in another aspect, the analysis region configuration unit 61 configures the analysis region in accordance with an operation of the user. In this case, the analysis region configuration unit 61 may configure the analysis region in accordance with input information of the user input via the operation unit 20. For example, an input video is displayed on the display unit 30 by the control unit 50, and the user specifies, via the operation unit 20, a region of a portion of the object in the input video displayed on the display unit 30. Then, the analysis region configuration unit 61 configures the region of the portion of the object thus input as the analysis region.

### Analysis Axis Configuration Unit 62

The analysis axis configuration unit 62 configures analysis axes for the vibration analyzing unit 63 to analyze the vibration of the object. In one aspect, the analysis axis configuration unit 62 configures the analysis axes in accordance with a video of the object. In this case, the analysis axis configuration unit 62 may analyze a direction of vibration of the analysis region configured by the analysis region configuration unit 61, and configure the analysis axes based on the analysis result.

Further, in another aspect, the analysis axis configuration unit 62 configures the analysis axes in accordance with an operation of the user. In this case, the analysis axis configuration unit 62 may configure the analysis axes in accordance with the input information of the user input via the operation unit 20. For example, possible directions of an analysis axis are displayed on the display unit 30 as a plurality of arrows rotatably extending from a black dot, and the user specifies the direction of the analysis axis via the operation unit 20 or the display unit 30 that includes the operation unit 20 such as a touch panel. Then, the analysis axis configuration unit 62 configures the analysis axis in the specified direction.

Here, in a case where an analysis axis is configured in a fixed direction such as a longitudinal direction or a lateral direction of the video, it may be difficult to suitably estimate the vibration of the object. In response, as described above, the analysis axis configuration unit 62 configures the analysis axes in a state in which the directions of the analysis axes can be changed in accordance with the video of the object or the operation of the user, making it possible to configure the analysis axes in suitable directions. As a result, the vibration of the object can be suitably analyzed.

### Vibration Analyzing Unit 63

The vibration analyzing unit 63 analyzes the vibration along each of the analysis axes of the object based on the input video. For example, the vibration analyzing unit 63 may analyze the vibration along each of the analysis axes configured on the analysis region configured by the analysis region configuration unit 61. More specifically, the vibration analyzing unit 63 calculates a displacement amount of the analysis region in each frame image of the object imaged in time series by the imaging unit 10. Thus, in addition to the displacement amount, the vibration analyzing unit 63 calculates vibration information such as a displacement direction, a displacement velocity, and a damping amount of the analysis region to analyze the vibration information.

The vibration analyzing unit 63 can calculate the displacement amount of the analysis region in each frame image by using a known method such as block matching. Further, the vibration analyzing unit 63 can calculate a position of a point on another frame image corresponding to the analysis region, such as a point configured on a reference image, using a predetermined frame image as the reference image. Thus, the displacement amount of the analysis region of the other frame image relative to the analysis region in the reference image can be calculated, and the displacement amount of the analysis region in time series can be calculated. Further, the vibration analyzing unit 63 can calculate the displacement direction, the displacement velocity, the damping amount, and other factors of the analysis region by analyzing the displacement amount of the analysis region in time series.

Note that, in the example described above, the vibration analyzing unit 63 analyzes vibration based on a video of the vibrating object imaged by the imaging unit 10, but the present embodiment is not limited thereto. In the present embodiment, the vibration analyzing unit 63 need not analyze vibration based on a video of the object imaged by the imaging unit 10, and may analyze vibration based on a video of the object imaged in advance.

### Output Unit 64

The output unit 64 outputs the analysis result obtained by the vibration analyzing unit 63 to an external source outside the vibration analysis device 60, such as the display unit 30. For example, the output unit 64 generates an image used for displaying the analysis result of the vibration, such as a displacement amount of the vibration analyzed by the vibration analyzing unit 63, on the display unit 30 and outputs the image data to the display unit 30. The output unit 64 may output an image in which the analysis result analyzed by the vibration analyzing unit 63 is superimposed onto the input video, or may output an image indicating the analysis result only. With this configuration, the analysis result of the vibration can be suitably displayed. Details of the image generated by the output unit 64 will be described later.

### Control Process of Vibration Analysis Device 60

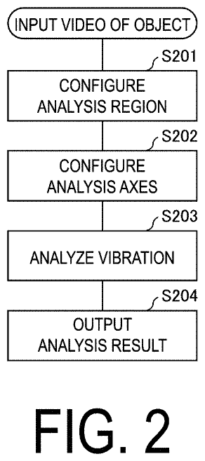

Next, a flow of a control process of the vibration analysis device 60 (control method for the vibration analysis device) according to the present embodiment will be described with reference to FIG. 2. FIG. 2 is a flowchart illustrating an example of the flow of the control process of the vibration analysis device 60. When a video of the object is input, the vibration analysis device 60 starts the processing in the following steps S201 to S204.

In step S201, the analysis region configuration unit 61 of the vibration analysis device 60 acquires the video of the object as an input video and configures an analysis region of the object in the input video.

In step S202, the analysis axis configuration unit 62 configures the analysis axes in accordance with the video of the object or an operation of the user relative to the analysis region configured by the analysis region configuration unit 61 (analysis axis configuration step).

In step S203, the vibration analyzing unit 63 analyzes the vibration along each of the analysis axes in the analysis region of the object based on the video of the object (vibration analyzing step).

In step S204, the output unit 64 outputs an analysis result, such as the displacement amount and the displacement direction of the analysis region of the object analyzed in step S203 (output step).

### Details of Analysis of Vibration by Vibration Analysis Device 60

Next, details of the analysis of vibration by the vibration analysis device 60 will be described using Processing Example 1 below.

### PROCESSING EXAMPLE 1

Configuration of Analysis Axes and Analysis of Vibration by Vibration Analysis Device 60

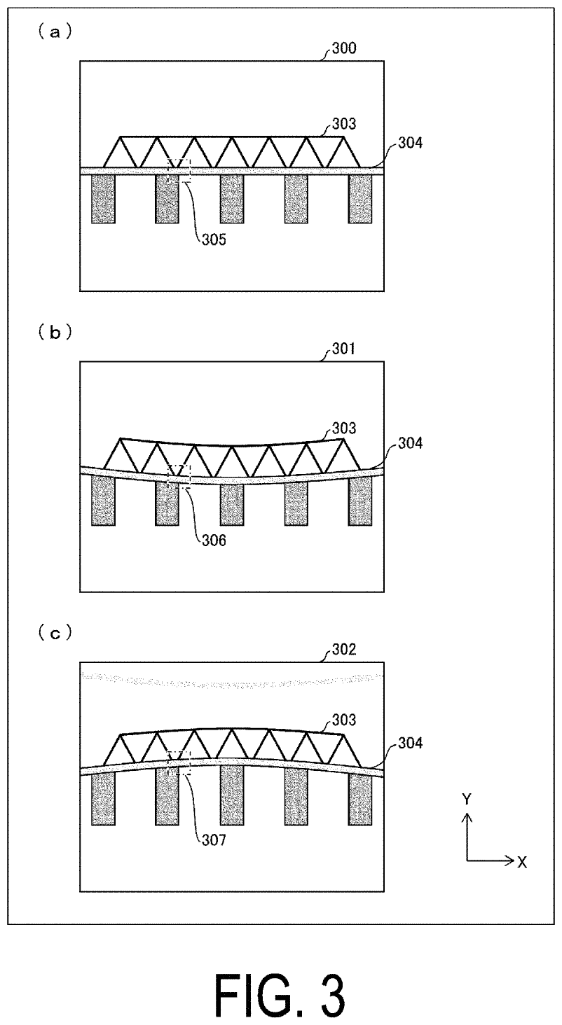

An example of the configuration of the analysis axes and the analysis of the vibration by the vibration analysis device 60 will be described with reference to FIG. 3. (a), (b), and (c) of FIG. 3 are drawings illustrating input videos (videos) 300, 301, 302 of a bridge (object) 303 imaged by the imaging unit 10. The input videos 300, 301, 302 are each one frame of one moving image (video), each captured at a different time. Further, the bridge 303 is vibrating, and in the input video 300 a bridge girder 304 of the bridge 303 is not deflected, in the input video 301 the bridge girder 304 is deflected downward, and in the input video 302 the bridge girder 304 is deflected upward. In the present processing example, the analysis axis configuration unit 62 of the vibration analysis device 60 configures an analysis axis in the Y-axis direction in accordance with a captured video of an object vibrating in an up-down direction (Y-axis direction) of the input video 302, as in the bridge 303 illustrated in FIG. 3, and the vibration analyzing unit 63 analyzes the vibration along the analysis axis. The region indicated by the dotted rectangle in the input video 300 indicates an analysis region 305 configured by the analysis region configuration unit 61. Analysis regions 306, 307, which are regions indicated by dotted rectangles in the input videos 301, 302, indicate regions corresponding to the analysis region 305 of the input video 300. The vibration analyzing unit 63 can analyze the vibration in the analysis region 305 of the bridge 303 based on the displacement amounts of the analysis regions 306, 307 relative to the analysis region 305, with the position of the analysis region 305 as the reference position. For example, in a case where the bridge 303 in the input video 301 is deflected farthest downward and the bridge 303 in the input video 302 is deflected farthest upward, the vibration analyzing unit 63 can calculate an amplitude (maximum-minimum) of the vibration of the analysis region 305 by subtracting the displacement amount of the analysis region 306 relative to the analysis region 305 from the displacement amount of the analysis region 307 relative to the analysis region 305.

Note that, in the example described above, the vibration analyzing unit 63 analyzes the displacement amount of the analysis region 305 based on the analysis regions 305, 306, 307, but the present embodiment is not limited thereto. In the present embodiment, the vibration analyzing unit 63 may calculate the displacement amount of the analysis region 305 relative to a non-moving point in the background in the input video. In this way as well, the vibration analyzing unit 63 can calculate the displacement amount of the analysis region 305, and suitably calculate the vibration of the analysis region 305.

Thus, the vibration analyzing unit 63 analyzes the vibration based on the displacement amount of the analysis region of the object (displacement amount of the object), making it possible to obtain the amplitude of the vibration and the like in the analysis region as an analysis result. This makes it possible to more suitably analyze the vibration of the object.

### Calculation Method for Displacement Amount of Analysis Region by Vibration Analysis Device 60

Below, a calculation method for the displacement amount of the analysis region corresponding to a predetermined analysis region will be described in detail. In a case where the vibration analyzing unit 63 calculates the displacement amount of the analysis region based on a video, the vibration analyzing unit 63 first establishes a predetermined frame image of the video of the object including the analysis region as a reference image. Next, the vibration analyzing unit 63 searches for a region corresponding to the analysis region of the reference image in another frame image (corresponding region), and calculates the displacement amount of the corresponding region in the other frame image relative to the analysis region of the reference image.

Examples of the method for searching for the corresponding region include a block matching method. A block matching method is a method of evaluating a degree of similarity between images, and is a method of searching other frame images for a region having the highest degree of similarity with the predetermined region in the reference image. Methods of searching for a region having a high degree of similarity include, for example, a method that uses an evaluation function, such as sum of absolute differences (SAD) and sum of squared differences (SSD). SAD is a function used to select, as the region with the highest degree of similarity, a region where the sum of the absolute values of the differences in pixel values or luminance values between the reference image and the other frame image is the smallest. SSD is a function used to select, as the region with the highest degree of similarity, a region where the sum of the squares of the differences in pixel values or luminance values between the reference image and the other frame image is the smallest. In the block matching method, the direction in which the search for the region having a high degree of similarity is conducted is preferably an array direction of the pixels of the frame image (for example, at least one of the horizontal axis (X-axis) direction and the vertical axis (Y-axis) direction). Thus, the displacement amount of the other frame image relative to the predetermined region of the reference image in the configured search direction can be calculated. Further, when, as a method for searching for a region having a high degree of similarity, two directions (for example, the X-axis direction and the Y-axis direction), which are the array directions of the frame image, are configured and a search is conducted for a region having a high degree of similarity, a two-dimensional displacement amount within the frame image plane can be calculated.

Examples of the method for searching for another corresponding region include a phase only correlation. With use of the phase only correlation, the product of phase components calculated by Fourier-transforming two images can be inverse Fourier-transformed to calculate a phase only correlation function. This makes it possible to calculate a relative shift in position of the two images from peak coordinates of a phase only correlation function. The phase only correlation has the advantage that a change in brightness between the images of the reference image and another frame image is intense. On the other hand, because the block matching method described above refers to the difference in pixel values or luminance values between the reference image and another frame image, the method is affected by changes in brightness between images. For example, in a case where videos of the object are captured outdoors, even when the videos of the object are captured from the same position, the brightness of the videos of the object may differ. Therefore, in a case where the block matching method is used, the search for a corresponding region is preferably conducted after, for example, averaging the overall brightness of the two images being compared and adjusting the pixel values so that the difference in brightness between the two images is small. Further, preferably, the reference image is not fixed to a predetermined frame image and, for example, two images arranged chronologically in time series are compared to calculate the difference in brightness, and finally the difference in brightness from the initial frame image in time series is calculated. Thus, the effect of a difference in brightness between images can be reduced and, as a result, the displacement amount of the analysis region can be suitably calculated. Note that, in a case where two images arranged chronologically in time series are successively compared, the displacement amount of the analysis region in the image of the initial frame, which is the reference image, can be calculated by adding the calculated displacement amount of the analysis region of the two images.

### Analysis of Vibration by Vibration Analysis Device 60

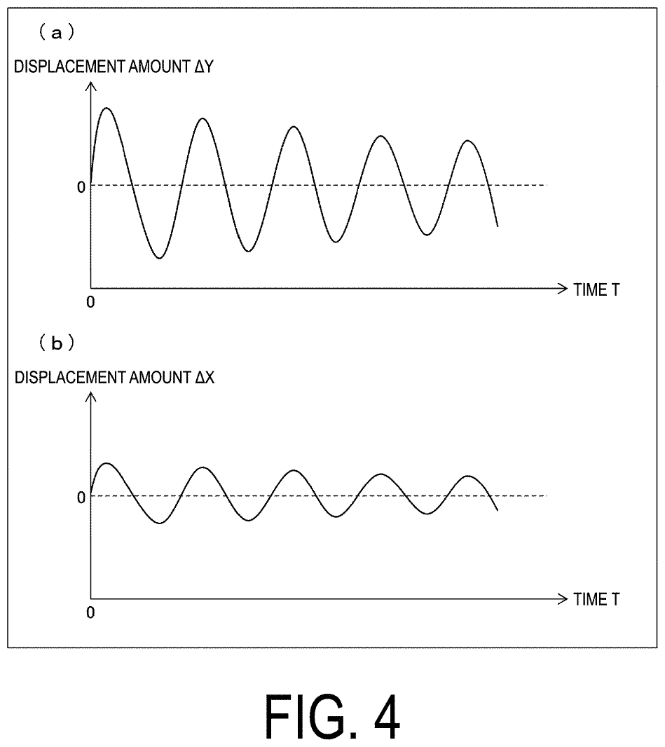

Next, the analysis of vibration by the vibration analysis device 60 in Processing Example 1 will be described in detail with reference to FIG. 4. FIG. 4 is a drawing illustrating an example of an analysis result of vibration obtained by the vibration analysis device 60 according to the first embodiment. Specifically, (a) of FIG. 4 is a drawing illustrating a change in the displacement amount of the analysis region 305 in the Y-axis direction relative to time, and (b) of FIG. 4 is a drawing illustrating a change in the displacement amount of the analysis region 305 in the X-axis direction relative to time. By calculating the displacement amounts of the analysis region 305 in the input video 300, as illustrated in (a) and (b) of FIG. 4, it is possible to obtain an analysis result of the vibration in the two directions of the Y-axis direction and the X-axis direction. Further, from the analysis result of the vibration illustrated in (a) and (b) of FIG. 4, it is understood that an amplitude of the vibration in the Y-axis direction is greater than an amplitude of the vibration in the X-axis direction, and a period of the vibration in the Y-axis direction and a period of the vibration in the X-axis direction are equal.

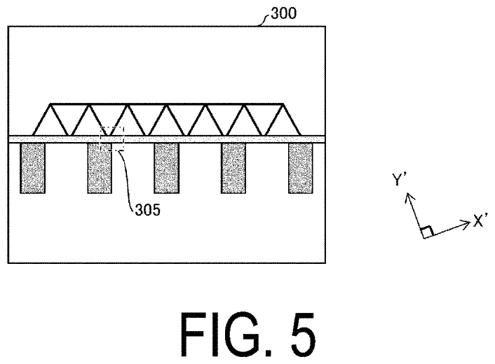

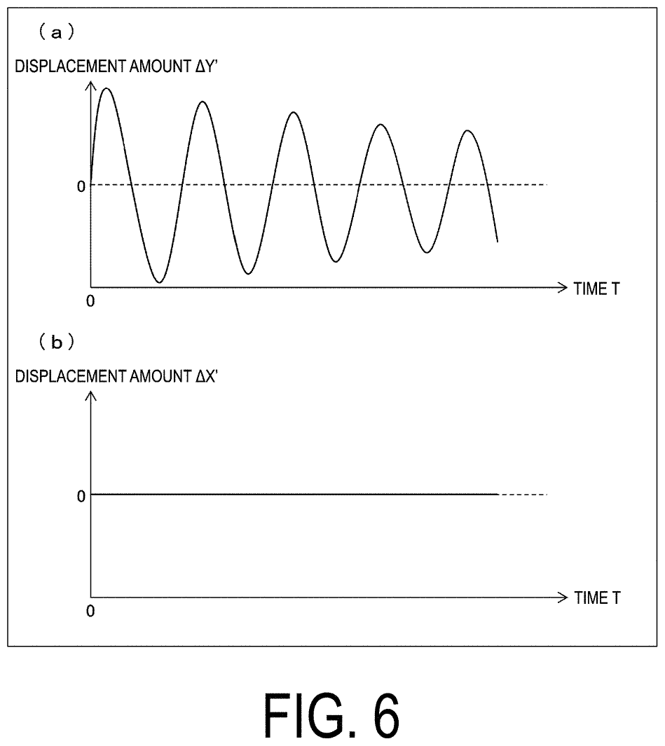

While, in the example described above, the analysis axes are configured in the two directions of the Y-axis and the X-axis in FIG. 4 and the results of analysis of the vibrations along the Y-axis and the X-axis are output, the present embodiment is not limited thereto. In the present embodiment, the analysis axes may be configured in directions other than those of the Y-axis and the X-axis, and an analysis result of the vibrations in those directions may be output. Below, a case where the analysis axes are configured in directions other than those of the Y-axis and the X-axis is described with reference to FIG. 5. FIG. 5 is a drawing for explaining an example of configuring the analysis axes in directions other those of the Y-axis and the X-axis. As illustrated in FIG. 5, the directions of the analysis axes in the analysis region 305 are configured to a Y′-axis direction and an X′-axis direction. FIG. 6 illustrates the analysis result of the vibration along each of the analysis axes in the case where the analysis axes are configured in the directions illustrated in FIG. 5. FIG. 6 is a drawing illustrating an example of the analysis result of vibration in a case where the analysis axes are configured in directions other than those of the Y-axis and the X-axis. Specifically, FIG. 6 is a drawing illustrating the displacement amount of the analysis region 305 in the input video 300. More specifically, (a) of FIG. 6 is a drawing illustrating a change in the displacement amount of the analysis region 305 in the Y′-axis direction relative to time, and (b) of FIG. 6 is a drawing illustrating a change in the displacement amount of the analysis region 305 in the X′-axis direction relative to time. From (a) of FIG. 6, it is understood that the analysis region 305 vibrates in the Y′-axis direction, and the amplitude of this vibration is greater than the amplitudes of the vibrations in the array direction of the pixels in the X-axis direction and the Y-axis direction illustrated in FIG. 4. On the other hand, from (b) of FIG. 6, it is understood that the analysis region 305 is not vibrating and the amplitude is zero in the X′-axis direction. That is, the analysis region 305 illustrated in FIG. 5 is understood to vibrate one dimensionally in the Y′-axis direction. Accordingly, depending on the directions in which the analysis axes are configured, an effect is obtained in which the maximum value of the amplitude of the vibration in the analysis region on the video increases. Further, as described above, in a case where the analysis region of the object is vibrating one dimensionally, an analysis axis is configured in the direction in which the analysis region is vibrating. This makes it possible to obtain an analysis result in which the amplitude of the vibration is greatest, and thus this configuration is preferred.

### PROCESSING EXAMPLE 2

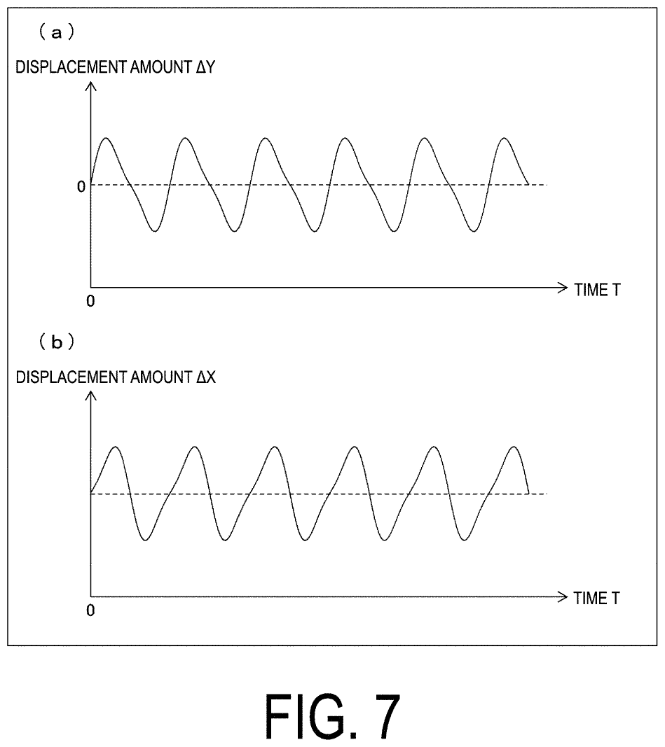

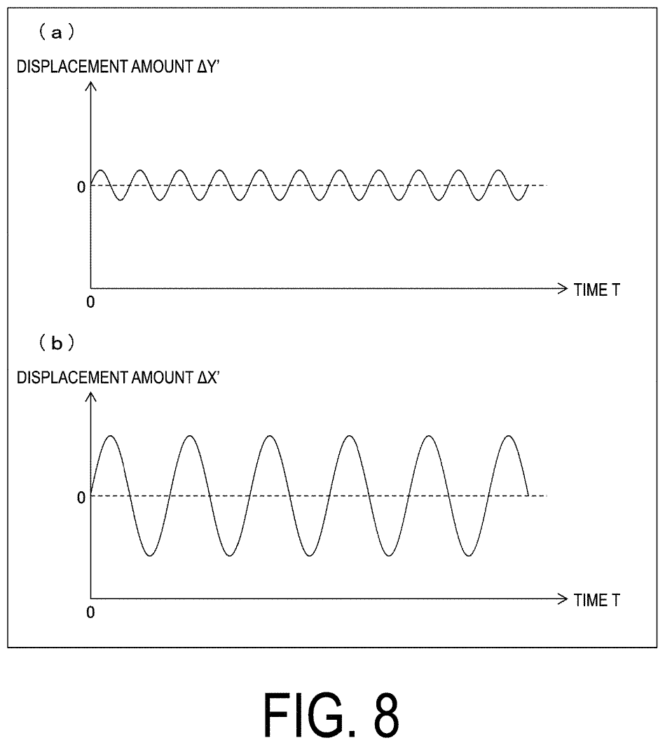

While Processing Example 1 describes a case where an analysis result in which the amplitude, the period (frequency), and the like of the vibration are understood from the displacement amount of the analysis region of the object is obtained, there are also cases in which an analysis result in which the amplitude, the period (frequency), and the like of the vibration are understood from the displacement amount of the analysis region cannot be obtained. Below, a case where it is difficult to obtain an analysis result in which the amplitude, the period (frequency), and the like of the vibration are understood from the displacement amount of the analysis region will be specifically described with reference to FIGS. 7 and 8. FIG. 7 is a drawing illustrating an example of an analysis result of vibration obtained by the vibration analysis device 60 according to the first embodiment. Specifically, (a) of FIG. 7 is a drawing illustrating a change in the displacement amount of a certain analysis region in the Y-axis direction relative to time, and (b) of FIG. 7 is a drawing illustrating a change in the displacement amount of a certain analysis region in the X-axis direction relative to time. From FIG. 7, it is understood that a certain analysis region vibrates in both the Y-axis direction and the X-axis direction. However, from FIG. 7, it is difficult to estimate the amplitude and the frequency at which the vibration vibrates in the video.

Thus, in a case where it is difficult to estimate vibration information such as amplitude and vibration frequency from the result of analyzing the displacement amount of the vibration using the analysis axes configured in certain directions, preferably the analysis axis configuration unit 62 changes the direction of at least one of the analysis axes to another direction in accordance with a video of the object or an operation of the user. Below, a case where the analysis axis configuration unit 62 changes the directions of the analysis axes to other directions, and the vibration analyzing unit 63 calculates the displacement amounts of the analysis region along the analysis axes after the change will be described with reference to FIG. 8. FIG. 8 is a drawing illustrating an example of an analysis result of vibration in a case where the analysis axes are changed to directions other than those of the Y-axis and the X-axis. Specifically, (a) of FIG. 8 is a drawing illustrating a change in the displacement amount relative to time in a certain analysis region in the Y′-axis direction obtained by rotating the Y-axis by 45 degrees. (b) of FIG. 8 is a drawing illustrating a change in the displacement amount relative to time in a certain analysis region in the X′-axis direction obtained by rotating the X-axis by 45 degrees. It is understood, from (a) of FIG. 8, that the vibration in the Y′-axis direction has a small amplitude and a large frequency and, from (b) of FIG. 8, that the vibration in the X′-axis direction has a large amplitude and a small frequency. Therefore, in a case where it is difficult to estimate vibration information such as frequency and amplitude from the displacement amounts of the vibration along each of the analysis axes configured in certain directions, a plurality of analysis axes are changed to appropriate directions, making it possible to suitably separate and analyze a plurality of vibrations and, from the plurality of suitably separated vibrations, obtain an analysis result of the frequency, the amplitude, and the like. Examples of changing a plurality of analysis axes to appropriate directions include the analysis axis configuration unit 62 configuring, in accordance with a video of the object, one of the analysis axes in a direction in which an amplitude of the vibration is greater than an amplitude in an array direction of the pixels of the video, or configuring one of the analysis axes in a direction in which the amplitude of the vibration is greatest. With the analysis axes configured in more suitable directions in accordance with the video of the object, it is possible to more suitably analyze the vibration of the object.

### PROCESSING EXAMPLE 3

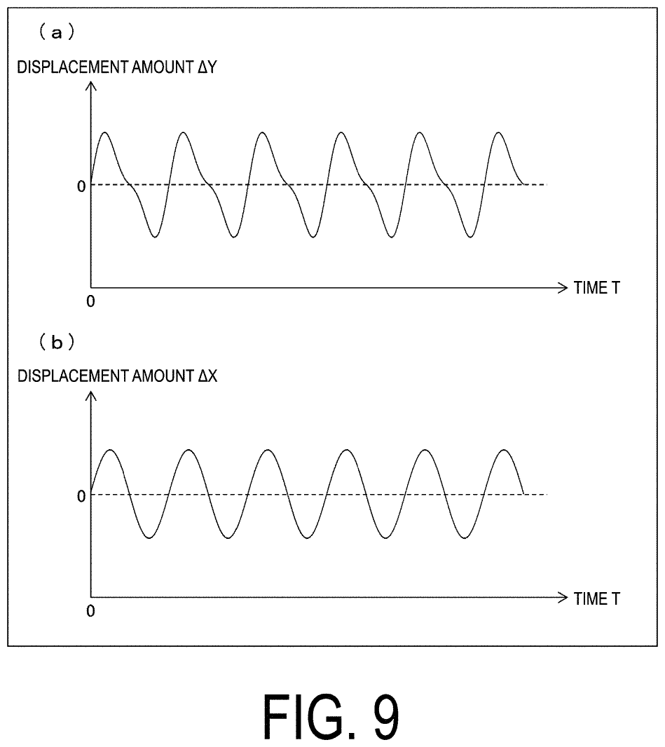

Processing Example 2 describes a case where it is difficult to estimate the amplitude and the frequency at which the vibration vibrates in a video from the displacement amounts of a certain analysis region in both the Y-axis direction and the X-axis direction. In contrast, there are cases where vibration information such as amplitude and frequency can be estimated from the displacement amount of the analysis region in the direction of one analysis axis, but estimating vibration information such as amplitude and frequency from the displacement amount of the analysis region in the direction of another analysis axis is difficult. In this case, the amplitude and the frequency of the vibration can be analyzed from the displacement amounts of the analysis region in the directions of both of the analysis axes by a method different from that in Processing Example 2. Below, a method for obtaining an analysis result such as an amplitude and a frequency of vibration by a method different from that in Processing Example 2 in a case where it is difficult to estimate vibration information such as amplitude and frequency from the displacement amount of the analysis region in the direction of one analysis axis will be specifically described with reference to FIGS. 9 to 11.

FIG. 9 is a drawing illustrating an example of an analysis result of vibration obtained by the vibration analysis device 60 according to the first embodiment. Specifically, (a) of FIG. 9 is a drawing illustrating a change in the displacement amount of a certain analysis region in the Y-axis direction relative to time, and (b) of FIG. 9 is a drawing illustrating a change in the displacement amount of a certain analysis region in the X-axis direction relative to time. From FIG. 9, it is understood that a certain analysis region vibrates in both the Y-axis direction and the X-axis direction. However, from (a) of FIG. 9, it is difficult to estimate how the vibration vibrates in the Y-axis direction.

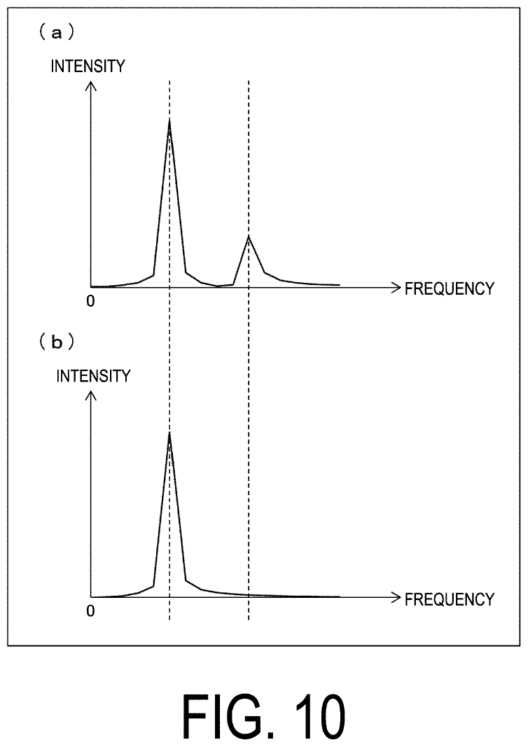

Thus, in a case where it is difficult to estimate the vibration information in the direction along one of the analysis axes, the vibration analyzing unit 63 preferably analyzes the vibration on a per frequency basis. Further, the analysis axis configuration unit 62 preferably changes the direction of at least one of the analysis axes to another direction based on the analysis result of the vibration at each frequency. In this way, the analysis axis is changed to a more suitable direction, and thus the vibration analyzing unit 63 can more suitably analyze the vibration of the object. Below, an example in which the vibration analyzing unit 63 analyzes the vibration on a per frequency basis and the analysis axis configuration unit 62 changes the direction of an analysis axis to another direction based on the analysis result of the vibration at each frequency will be described with reference to FIGS. 10 to 12.

FIG. 10 is a graph showing a relationship between frequency and intensity of the vibration illustrated in FIG. 9. Specifically, (a) of FIG. 10 is a graph showing the relationship between the frequency and the intensity of the vibration in the Y-axis direction illustrated in (a) of FIG. 9, and (b) of FIG. 10 is a graph showing a relationship between the frequency and the intensity of the vibration in the X-axis direction illustrated in (b) of FIG. 9. As shown in (a) of FIG. 10, the vibration in the Y-axis direction has a peak of high intensity in two different frequency ranges of a low frequency range and a high frequency range, and the vibration in the X-axis direction has a peak of high intensity in one frequency range. Further, of the two peak frequencies in the Y-axis direction, the peak frequency in the low frequency range is the same as the peak frequency in the X-axis direction. Accordingly, of the two peak frequencies in the Y-axis direction, the vibration of the peak frequency in the high frequency range is considered to be a vibration specific to the Y-axis direction.

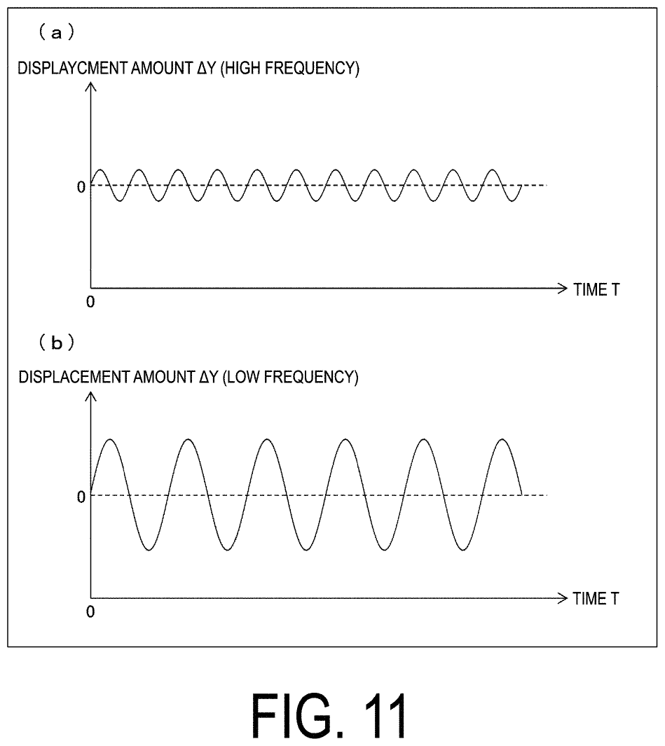

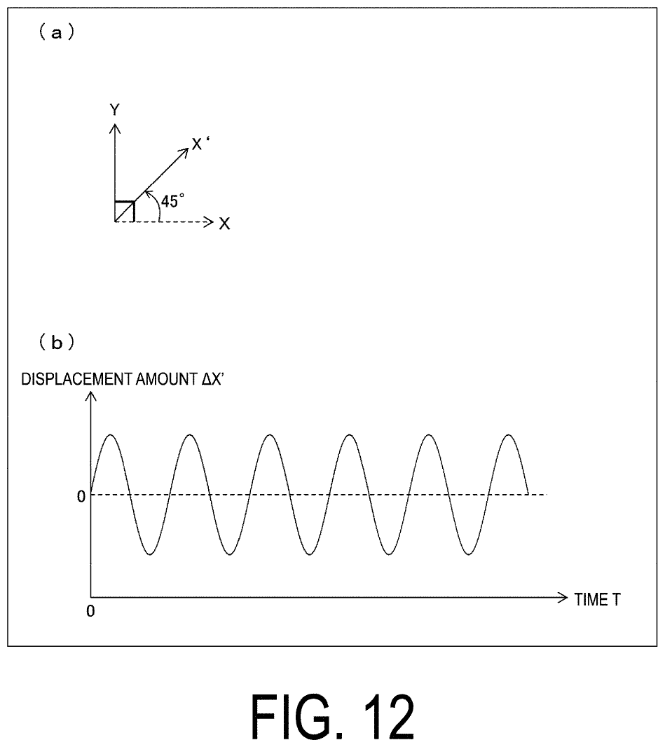

Next, a case where the vibration analyzing unit 63 separates the vibration into two vibrations of the vibration of a low frequency and the vibration of a high frequency in the Y-axis direction shown in (a) of FIG. 10 is described using FIG. 11. FIG. 11 is a drawing illustrating an example of an analysis result of vibration analyzed on a per frequency basis. Specifically, (a) of FIG. 11 is a drawing illustrating an analysis result of vibration of a high frequency specific to the Y-axis direction, and (b) of FIG. 11 is a drawing illustrating an analysis result of vibration of a low frequency in the Y-axis direction. Here, the high amplitude vibration of the low frequency illustrated in FIG. 11(b) has the same frequency as that of the vibration in the X-axis direction illustrated in FIG. 9(b), and thus the vibration may be the same. In this way, in a case where the vibration in the X-axis direction and the vibration in the Y-axis direction may be the same vibration, the analysis axis configuration unit 62 may change the direction of at least one analysis axis to a direction between the X-axis direction and the Y-axis direction. Below, a case where the analysis axis configuration unit 62 changes the direction of an analysis axis to a direction between the X-axis direction and the Y-axis direction will be described with reference to FIG. 12. FIG. 12 is a drawing for explaining a case where a direction of an analysis axis is changed from the X-axis direction to a direction between the X-axis direction and the Y-axis direction. Specifically, (a) of FIG. 12 is a drawing illustrating the analysis axis configuration unit 62 changing the direction along the analysis axis of vibration of a low frequency observed in both the X-axis direction and the Y-axis direction to an X′-axis direction obtained by rotating the X-axis by 45 degrees relative to the X-axis. (b) of FIG. 12 is a drawing illustrating the analysis result of the vibration of a frequency in the X′-axis direction. As shown in (b) of FIG. 12, the vibrations of the low-frequency observed in the X-axis direction and the Y-axis direction can be expressed as one vibration in a direction rotated 45 degrees relative to the X-axis. Thus, the vibration illustrated in FIG. 9 can be separated into two vibrations that vibrate independently in two directions, that is, a vibration in the Y-axis direction and a vibration in the X′-axis direction rotated 45 degrees relative to the X-axis. Thus, in a case where a plurality of analysis axes are to be configured, the analysis axis configuration unit 62 does not always need to configure the plurality of analysis axes in orthogonal directions, and may configure two analysis axes having an angle formed by the analysis axes that is not 90 degrees, that is, two analysis axes that are not orthogonal to each other, as illustrated in Processing Example 3. Thus, in a case where analysis axes orthogonal to each other are configured and it is difficult to estimate the vibration information in the direction along at least one of the analysis axes, the analysis axes may be changeable to more suitable directions. By thus changing the analysis axes to suitable directions, the vibration analyzing unit 63 can more suitably analyze the vibration of the object.

Note that while, in the example described above, a case where it is difficult to estimate the amplitude and the frequency of the vibration from the analysis region in the direction of one analysis axis is described, the present embodiment is not limited thereto. In the present embodiment, in a case where it is difficult to estimate the amplitude, the frequency, and the like of the vibration from the analysis region in both the vertical direction (Y-axis direction) and the horizontal direction (X-axis direction) of the input video as in Processing Example 2, the vibration analyzing unit 63 may analyze the vibration of the analysis region on a per frequency basis. Then, the analysis axis configuration unit 62 may change the direction of at least one analysis axis to another direction based on the analysis result of the vibration at each frequency. According to this as well, similar to the examples described above, the vibration of the object can be suitably analyzed.

### Effect of Vibration Analysis System 1 According to First Embodiment

As described above, the vibration analysis system 1 according to the first embodiment changeably configures the analysis axes, making it possible to separate and observe a plurality of vibrations and make observations in directions having large amplitudes. This makes it possible to suitably analyze the vibration of the object.

### Second Embodiment

In the vibration analysis system 1 according to the first embodiment described above, the analysis axis configuration unit 62 configures the analysis axes in a one-dimensional direction or in two-dimensional directions. However, as in a vibration analysis system 2 (not illustrated) according to a second embodiment, an analysis axis configuration unit 72 (not illustrated) in a vibration analysis device 70 (not illustrated) may configure the analysis axes in three-dimensional directions.

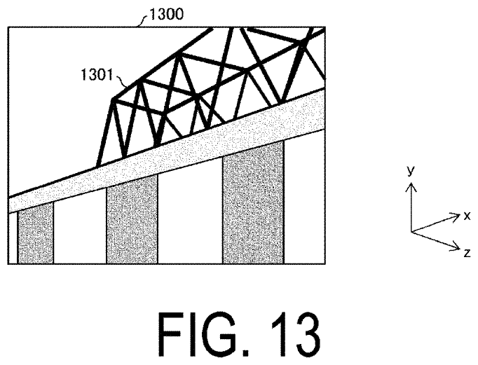

Below, the vibration analysis system 2 according to the second embodiment will be described with reference to FIGS. 13 to 16. Note that, for the sake of description, components having functions the same as the functions of the components described in the first embodiment are denoted by the same reference signs, and description thereof will be herein omitted.

### Vibration Analysis System 2

The vibration analysis system 2 includes the vibration analysis device 70 in place of the vibration analysis device 60 according to the first embodiment. Other than this, the vibration analysis system 2 has the same configuration as the vibration analysis system 1 according to the first embodiment.

### Vibration Analysis Device 70

The vibration analysis device 70 includes the analysis axis configuration unit 72 and a vibration analyzing unit 73 (not illustrated) in place of the analysis axis configuration unit 62 and the vibration analyzing unit 63 in the first embodiment, respectively. Other than this, the vibration analysis device 70 has the same configuration as the vibration analysis device 60 according to the first embodiment.

### Analysis Axis Configuration Unit 72

The analysis axis configuration unit 72 includes a distance information acquisition unit 720 (not illustrated) configured to acquire distance information regarding a distance between the imaging unit 10 and the object. The analysis axis configuration unit 72 configures the analysis axes in accordance with the distance information.

Note that the distance information acquisition unit 720 can acquire distance information, such as the distance between the imaging unit 10 and the object and three-dimensional positional information of the object relative to the imaging unit 10, by a known method. For example, the imaging unit 10 includes two cameras having different viewpoints, such as a stereo camera. In this case, the distance information acquisition unit 720 can calculate the distance from the camera to the object from a parallax of the video (image) captured by the two cameras, with reference to a focal length and the like of each camera. Thus, the distance information acquisition unit 720 can acquire three-dimensional positional information of the object based on the distance from each camera to the object and the position of the object on the image. Further, the object can be irradiated with a laser beam, the distance from the imaging unit 10 to the object can be calculated based on an arrival time of reflected light of the laser beam, and the three-dimensional positional information of the object can be acquired based on the distance.

### Vibration Analyzing Unit 73

The vibration analyzing unit 73 analyzes the vibration of the object based on a three-dimensional displacement amount of the object. Thus, even in a case where it is difficult to estimate vibration information when analyzing the vibration of an object in a two-dimensional video, the vibration analyzing unit 73 can analyze the vibration of the object based on three-dimensional positional information or the like of the object. For example, the vibration analyzing unit 73 can, by referring to the three-dimensional positional information of the object, convert a displacement amount of the analysis region on the input video into an amplitude of the vibration on a three-dimensional space. As a result, the vibration analyzing unit 73 can analyze the vibration direction, the amplitude, and the like on the three-dimensional space of the object, making it possible to more suitably analyze the vibration of the object.

### Details of Analysis of Vibration by Vibration Analysis Device 70

Below, details of the analysis of vibration by the vibration analysis device 70 according to the second embodiment will be described below using the following Processing Example 4.

### PROCESSING EXAMPLE 4

### Object Subject to Configuration of Analysis Axes by Analysis Axis Configuration Unit 72

An example of an object subject to configuration of analysis axes by the analysis axis configuration unit 72 will be described with reference to FIG. 13. FIG. 13 is a drawing illustrating an example of a video of an object. Specifically, FIG. 13 is a drawing illustrating an input video 1300 of a bridge (object) 1301 captured by the imaging unit 10. In FIG. 13, an x-axis, a y-axis, and a z-axis each indicate a direction of an analysis axis in a three-dimensional space. The x-axis direction is a direction parallel to a longitudinal direction of the bridge 1301, the y-axis direction is the vertical direction, and the z-axis direction is a lateral direction of the bridge 1301, orthogonal to the x-axis. The bridge 1301 is imaged from a direction obliquely looking up toward the bridge 1301 from below, and oblique to the longitudinal direction (x-axis direction) of the bridge 1301.

### Positional Relationship Between Imaging Unit 10 and Bridge 1301

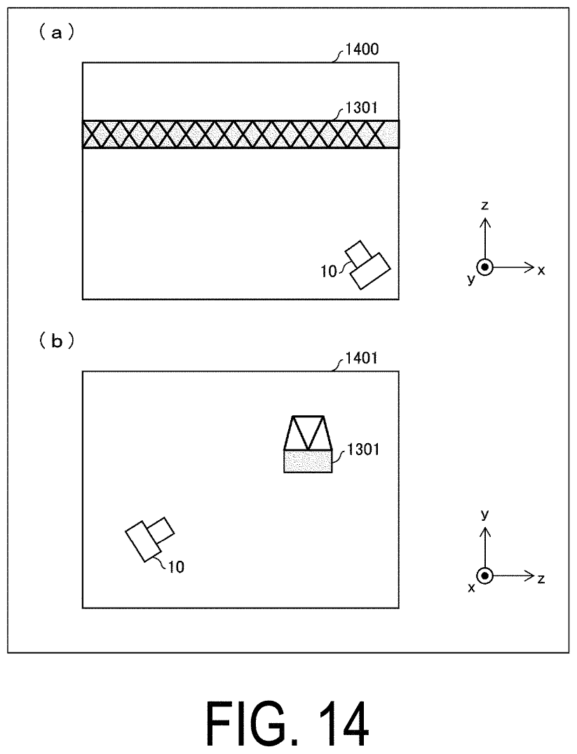

Next, an example of the positional relationship between the imaging unit 10 and the bridge 1301 will be described with reference to FIG. 14. FIG. 14 is a drawing illustrating an example of a positional relationship between the imaging unit 10 and the object. Specifically, (a) and (b) of FIG. 14 are drawings illustrating the positional relationship between the imaging unit 10, which images the input video 1300, and the bridge 1301. (a) of FIG. 14 illustrates an xz plan view 1400, which is a bird's-eye view of the bridge 1301 and the imaging unit 10 from top to bottom in the y-axis direction. As illustrated in (a) of FIG. 14, the imaging unit 10 images the bridge 1301 from a direction inclined in the x-axis direction relative to the z-axis. (b) of FIG. 14 illustrates a yz plan view 1401 from the longitudinal direction (x-axis) of the bridge 1301. As illustrated in (b) of FIG. 14, the imaging unit 10 images the bridge 1301 from a direction inclined in the y-axis direction relative to the z-axis. That is, the imaging unit 10 images the bridge 1301 from a direction obliquely looking up toward the bridge from below.

### Configuration of Analysis Axes and Analysis of Vibration by Vibration Analysis Device

Next, the configuration of analysis axes and the analysis of vibration by the vibration analysis device 70 will be described. The bridge 1301 vibrates in the y-axis direction, which is the vertical direction and a direction perpendicular to the x-axis, which is the longitudinal direction of the bridge 1301, and in the z-axis direction, which is the lateral direction of the bridge 1301 and a direction level with the surface of the bridge 1301. As is clear from FIGS. 13 and 14, the imaging direction of the bridge 1301 by the imaging unit 10 is neither in a perpendicular direction relative to or coincident with the vibration directions of the object in the input video 1300. Therefore, the imaging unit 10 cannot image the bridge 1301 from a position suitable for analysis of vibration of the bridge 1301. Accordingly, as in the first embodiment, in a case where the analysis axes are configured in accordance with a two-dimensional input video, the vibration of the bridge 1301 may not always be suitably analyzed, depending on the positional relationship between the imaging unit 10 and the object. In this embodiment, the analysis axis configuration unit 72 includes the distance information acquisition unit 720 that acquires distance information, such as three-dimensional positional information, of the bridge 1301 relative to the imaging unit 10, and the analysis axis configuration unit 72 can configure the analysis axes in accordance with the distance information. Thus, even in a case where the imaging direction of the bridge 1301 by the imaging unit 10 is neither in a perpendicular direction relative to or coincident with the vibration directions of the object in the input video 1300, the vibration analyzing unit 73 can suitably analyze the vibration of the bridge 1301 based on a three-dimensional displacement amount of the object from three-dimensional positional information or the like of the object.

### Specific Example 1 of Configuration of Analysis Axes and Analysis of Vibration by Vibration Analysis Device 70

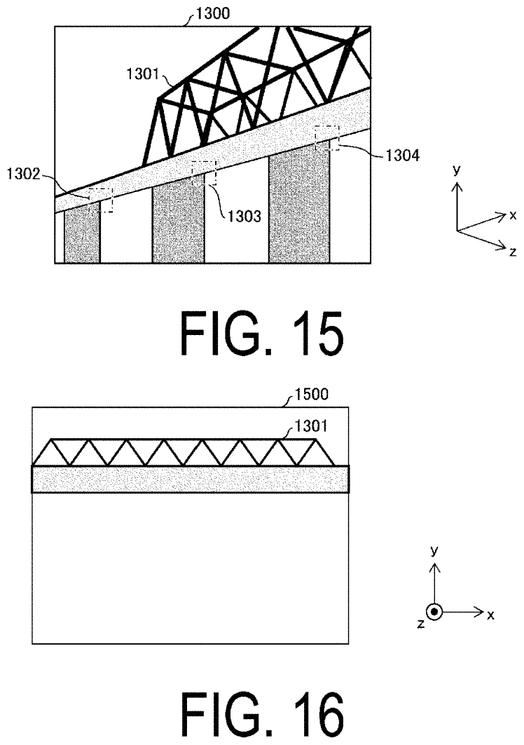

A Specific Example 1 of the configuration of the analysis axes and the analysis of the vibration by the vibration analysis device 70 will be described with reference to FIG. 15. FIG. 15 is a drawing illustrating an example of a video of an object. Specifically, FIG. 15 is a drawing illustrating the input video 1300 with the bridge 1301 imaged in the same manner as in FIG. 13. As illustrated in FIG. 15, three analysis regions 1302, 1303, 1304 indicated by dotted rectangles are configured in the input video 1300.

Below, a case where the vibration along the analysis axis in the y-axis direction of the bridge 1301 is analyzed will be described. As described with reference to FIG. 14, because the imaging unit 10 images the bridge 1301 from a direction obliquely looking up toward the bridge 1301 from below, the vertical direction of the input video 1300 and the vertical direction of the three-dimensional space (y-axis direction) do not coincide. Accordingly, even when an analysis axis is configured in the vertical direction of the input video 1300 in accordance with the input video 1300 and the vibration along the analysis axis is analyzed, the vibration in the vertical direction of the bridge 1301 in the three-dimensional space cannot be accurately analyzed. Further, the imaging unit 10 images the bridge 1301 from a direction inclined in the x-axis direction relative to the z-axis. Therefore, even in a case where different regions on the input video 1300 vibrate at the same amplitude, the displacement amount on the input video 1300 is larger on the right side of the input video 1300 and smaller on the left side of the input video 1300. For example, if an explanation is given using the analysis regions 1302, 1303, 1304 in FIG. 15, in a case where the amplitudes of the vibrations in the three analysis regions are the same, the displacement amount on the input video 1300 is largest in the analysis region 1304 and smallest in the analysis region 1302. Accordingly, in order to analyze the difference in amplitude of the vibrations according to positions on the bridge 1301, it is necessary to analyze the amplitudes of the vibrations in the analysis regions 1302, 1303, 1304 in the three-dimensional space rather than the displacement amounts of the analysis regions 1302, 1303, 1304 on the input video 1300.

Here, the distance information acquisition unit 720 in the analysis axis configuration unit 72 acquires each of the distances from the imaging unit 10 to the analysis regions 1302, 1303, 1304 of the bridge 1301, and acquires the three-dimensional positional information of the analysis regions 1302, 1303, 1304. Thus, the analysis axis configuration unit 72 can configure analysis axes in the y-axis direction, which is the vertical direction in the three-dimensional space. Furthermore, the vibration analyzing unit 73 can analyze the vibrations in these analysis regions in the y-axis direction, which is the direction of the analysis axes.

Thus, even in a case where the imaging unit 10 is substantially not directly facing the object (in a case where none of the analysis axes are configured in a direction connecting the imaging unit 10 and the object), the amplitudes on three-dimensional spaces in a plurality of different analysis regions of the object can be compared, and the amplitude of the vibration in each of the analysis regions can be analyzed.

### Specific Example 2 of Configuration of Analysis Axes and Analysis of Vibration by Vibration Analysis Device 70

In Specific Example 1 described above, the configuration of the analysis axes and the analysis of the vibration by the vibration analysis device 70 in a case where the imaging unit 10 is not directly facing the object is described. However, the imaging unit 10 and the object may be substantially directly facing each other. Below, a Specific Example 2 of the configuration of the analysis axes and the analysis of the vibration by the vibration analysis device 70 in a case where the imaging unit 10 and the object substantially directly face each other (a case where one of the analysis axes is configured in a direction connecting the imaging unit 10 and the object) will be described with reference to FIG. 16. FIG. 16 is a drawing illustrating an example of a video of an object. Specifically, FIG. 16 is a drawing illustrating an input video 1500 in which the bridge 1301 is imaged from the z-axis direction. As illustrated in FIG. 16, an optical axis of the imaging unit 10 is oriented in the z-axis direction, and the imaging unit 10 directly faces the object and images the bridge 1301. Thus, in a case where the imaging unit 10 images the bridge 1301 while directly facing the bridge 1301, a depth direction (z-axis direction in three-dimensional space) of the bridge 1301 in the input video 1500 coincides with the optical axis of the imaging unit 10. Therefore, it is not easy to analyze the vibration in the z-axis direction based on the input video 1500.

Here, the distance information acquisition unit 720 in the analysis axis configuration unit 72 acquires the distance from the imaging unit 10 to the bridge 1301 to acquire the three-dimensional positional information of the bridge 1301. As a result, even when the analysis axis configuration unit 72 configures an analysis axis in the z-axis direction, the vibration analyzing unit 73 can analyze the vibration of the bridge 1301 vibrating in the same direction as the optical axis of the imaging unit 10 based on the three-dimensional positional information of the bridge 1301.

Thus, even in a case where the analysis axis configuration unit 72 has configured one of the analysis axes in a direction connecting the imaging unit 10 and the object, the vibration analyzing unit 73 can suitably analyze the vibration of the object based on the three-dimensional displacement amount of the object from the three-dimensional positional information or the like of the object.

### Third Embodiment

In the vibration analysis systems 1, 2 according to the first and second embodiments described above, the analysis axis configuration units 62, 72 configure analysis axes in the same directions for all analysis regions. However, as in a vibration analysis system 3 (not illustrated) according to a third embodiment, an analysis axis configuration unit 82 (not illustrated) in a vibration analysis device 80 (not illustrated) may configure different analysis axes for each of the plurality of analysis regions.

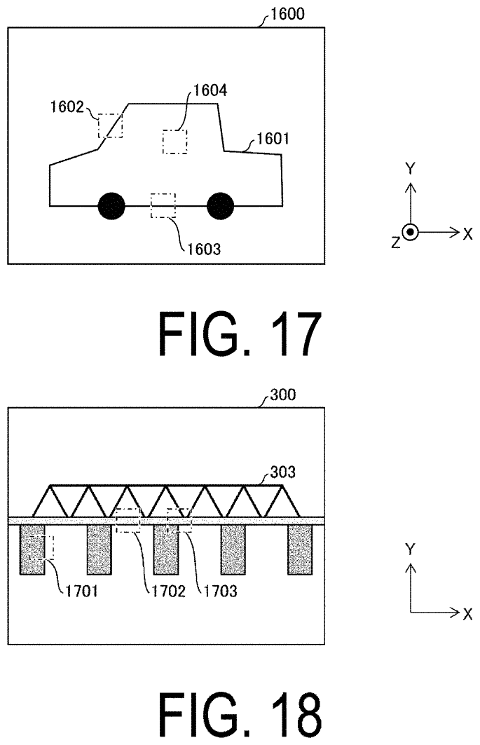

Below, the vibration analysis system 3 according to the third embodiment will be described based on FIGS. 17 and 18. Note that, for the sake of description, components having functions the same as the functions of the components described in the embodiments described above are denoted by the same reference signs, and description thereof will be herein omitted.

### Vibration Analysis System 3

The vibration analysis system 3 includes the vibration analysis device 80 in place of the vibration analysis device 60 according to the first embodiment. Other than this, the vibration analysis system 3 has the same configuration as the vibration analysis system 1 according to the first embodiment.

### Vibration Analysis Device 80

The vibration analysis device 80 includes the analysis axis configuration unit 82 and a vibration analyzing unit 83 (not illustrated) in place of the analysis axis configuration unit 62 and the vibration analyzing unit 63 in the first embodiment, respectively. Other than this, the vibration analysis device 80 has the same configuration as the vibration analysis device 60 according to the first embodiment.

### Analysis Axis Configuration Unit 82

The analysis axis configuration unit 82 configures the analyses axes in accordance with an input video for each of the plurality of analysis regions of the object. For example, the analysis axis configuration unit 82 may configure analysis axes in different directions for each analysis region of the object in the input video, or may configure analysis axes in the same directions for all analysis regions. Further, the analysis axis configuration unit 82 may configure analysis axes in the same directions for some of the analysis regions, and configure analysis axes in different directions for some of the analysis regions. Thus, the analysis axis configuration unit 82 can more suitably configure the analysis axes.

### Vibration Analyzing Unit 83

The vibration analyzing unit 83 analyzes vibration along the analysis axes of the object based on the input video on a per analysis region basis. Thus, the vibration analyzing unit 83 can more suitably analyze the vibrations in the analysis regions of the object.

### Details of Analysis of Vibration by Vibration Analysis Device 80

Below, details of the analysis of vibration by the vibration analysis device 80 according to the third embodiment will be described using the following Processing Examples 5 and 6.

### PROCESSING EXAMPLE 5

An example of the configuration of the analysis axes and the analysis of the vibration by the vibration analysis device 80 will be described using FIG. 17. FIG. 17 is a drawing illustrating an example of a video of an object. Specifically, FIG. 17 is a drawing illustrating an input video 1600 of an automobile (object) 1601 imaged by the imaging unit 10. As illustrated in FIG. 17, three analysis regions 1602, 1603, 1604 indicated by dotted rectangles are configured in the input video 1600. An object formed of multiple components such as the automobile 1601, and an object in which a plurality of vibration sources exist within the object are not necessarily limited to vibrating in the same direction in their entirety, and may vibrate in different directions depending on the position within the object. For example, in a case where the analysis region 1602 illustrated in FIG. 17 is vibrating in a direction from an upper left to a lower right on the input video 1600 and the analysis region 1603 vibrates in an up-down direction (Y-axis direction) on the input video 1600, the directions in which the two analysis regions vibrate differ.

Here, in accordance with the input video 1600, the analysis axis configuration unit 82 configures an analysis axis in the direction from the upper left to the lower right for the analysis region 1602, and configures an analysis axis in the Y-axis direction of the input video 1600 for the analysis region 1603. Further, the vibration analyzing unit 83 analyzes the vibrations in these analysis regions along the analysis axes respectively configured for the analysis region 1602 and the analysis region 1603. Thus, with the analysis axes configured in the same directions as the respective directions in which the analysis regions 1602, 1603 vibrate, the vibration analyzing unit 83 can analyze the vibration having the largest amplitude in each analysis region. This makes it possible to more suitably analyze the vibrations of the analysis regions.

Note that while, in the example described above, the analysis axis configuration unit 82 configures the analysis axes in accordance with the two-dimensional input video 1600 for each of the plurality of analysis regions, the present embodiment is not limited thereto. In the present embodiment, the analysis axes may be configured in three-dimensional directions, as in the analysis axis configuration unit 72 according to the second embodiment. For example, in a case where the analysis region 1604 in FIG. 17 is vibrating in the depth direction (Z-axis direction) of the input video 1600, it is difficult to analyze the vibration of the analysis region 1604 by configuring the analysis axes in accordance with the input video 1600. However, by the analysis axis configuration unit 82 configuring an analysis axis in the z-axis direction in accordance with the distance information in the same way as the analysis axis configuration unit 72, the vibration analyzing unit 83 can analyze the vibration of the analysis region 1604 based on the three-dimensional positional information of the analysis region 1604. Thus, even in a case where the analysis axis configuration unit 82 configures an analysis axis in the depth direction of the video, the vibration analyzing unit 83 can suitably analyze the vibration of the analysis region 1604 as well based on the three-dimensional displacement amount of the analysis region 1604.

### PROCESSING EXAMPLE 6

The analysis axis configuration unit 82 may configure the analysis axes in accordance with video information on a per analysis region basis. Below, an example of the configuration of the analysis axes and the analysis of the vibration by the vibration analysis device 80 will be described with reference to FIG. 18. FIG. 18 is a drawing illustrating an example of a video of an object. Specifically, FIG. 18 is a drawing illustrating the input video 300 of the bridge (object) 303 imaged by the imaging unit 10, similar to FIGS. 3 and 5. As illustrated in FIG. 18, three analysis regions 1701, 1702, 1703 indicated by dotted rectangles are configured in the input video 300.

For example, the analysis region 1701 is a region having an edge in the vertical direction (Y-axis direction) of the input video 300, and thus the analysis axis configuration unit 82 configures an analysis axis in the horizontal direction (X-axis direction). The vibration analyzing unit 83 analyzes the vibration by calculating the displacement amount of the analysis region 1701 along the analysis axis in the X-axis direction. In general, a region having an edge in the vertical direction of the video is likely to have a similar pattern continuous in the vertical direction, and thus it is difficult to accurately calculate the displacement amount in the vertical direction in the region by the block matching method. Therefore, a calculation error in the displacement amount of the region may increase, and an error in the analysis result of depth may also increase. On the other hand, a region having an edge in the vertical direction does not have a similar pattern continuous in the horizontal direction orthogonal to the direction of the edge, making it likely that the displacement amount in the horizontal direction can be accurately calculated. Therefore, as described above, the analysis axis configuration unit 82 calculates the displacement amount of the analysis region 1701 in the horizontal direction orthogonal to the direction of the edge, thereby making it possible for the vibration analyzing unit 83 to obtain the vibration in the horizontal direction of the analysis region 1701 as an analysis result. This makes it possible to more suitably analyze the vibration.

Similarly, the analysis region 1702 is a region having an edge in the horizontal direction (X-axis direction) of the video, and thus the analysis axis configuration unit 82 configures an analysis axis in the Y-axis direction. The vibration analyzing unit 83 analyzes the vibration by calculating the displacement amount of the analysis region 1703 along the analysis axis in the Y-axis direction. Further, the analysis region 1703 is a region having edges in the X-axis direction and the Y-axis direction, and thus the analysis axis configuration unit 82 may configure analysis axes in the two directions of the X-axis direction and the Y-axis direction, or may configure an analysis axis in either one of the directions. In these cases as well, the vibration can be suitably analyzed in the same manner as in the examples described above.

Further, while, in the example described above, the analysis axis configuration unit 82 configures the analysis axes in accordance with the video information, the video information being the direction of an edge, on a per analysis region basis, the present embodiment is not limited thereto. In the present embodiment, the analysis axis configuration unit 82 may configure the analysis axes in accordance with features of the input video overall. In general, the object readily vibrates in a direction orthogonal to the longitudinal direction, and thus the analysis axis configuration unit 82 may configure an analysis axis in a direction orthogonal to the longitudinal direction of the object. For example, the bridge 303 in the input video 300 in FIG. 18 is a horizontally long object relative to the horizontal direction (X-axis direction) of the input video 300, and thus it is likely that the object vibrates in the up-down direction (Y-axis direction) of the input video 300. Therefore, the analysis axis configuration unit 82 configures an analysis axis in the Y-axis direction and the vibration analyzing unit 83 calculates the displacement amount of the bridge 303 along the analysis axis in the Y-axis direction, making it possible to analyze the vibration in a direction in which the amplitude is large and thus suitably analyze the vibration.

### Fourth Embodiment

As in a vibration analysis system 4 (not illustrated) according to a fourth embodiment, a display unit 130 (not illustrated) may display the analysis axes superimposed onto the video of the object.

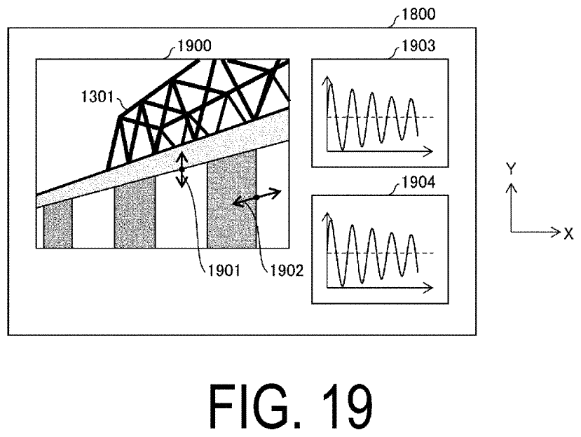

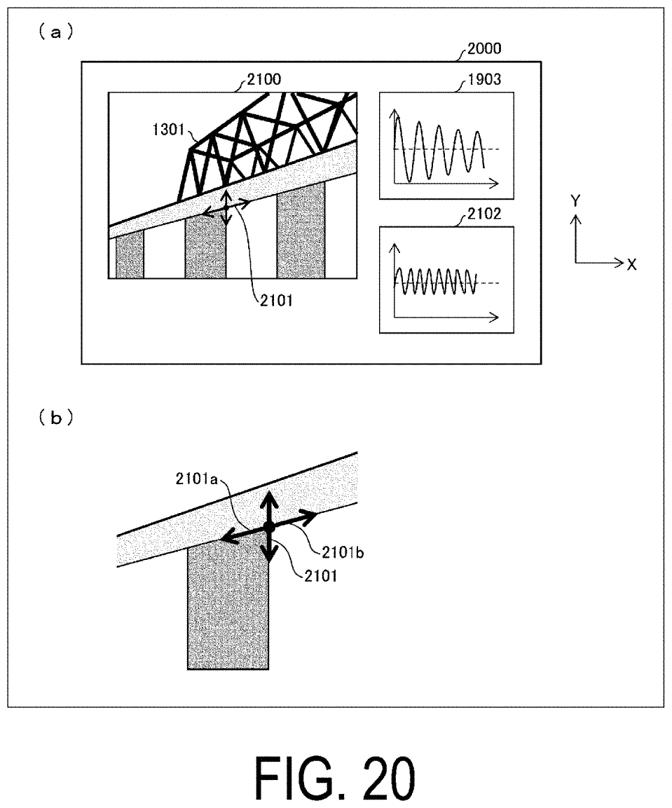

Below, the vibration analysis system 4 according to the fourth embodiment will be described based on FIGS. 19 and 20. Note that, for the sake of description, components having functions the same as the functions of the components described in the embodiments described above are denoted by the same reference signs, and description thereof will be herein omitted.

### Vibration Analysis System 4

The vibration analysis system 4 includes the display unit 130 instead of the display unit 30 in the first embodiment. Other than this, the vibration analysis system 4 has the same configuration as the vibration analysis system 1 according to the first embodiment.

### Display Unit 130

The display unit 130 displays the analysis axes superimposed onto the video of the object.

### Details of Display of Image by Display Unit 130

Below, the details of the display of an image by the display unit 130 will be described using the following Processing Example 7.

### PROCESSING EXAMPLE 7

### Specific Example 1 of Display of Image by Display Unit 130

A specific example 1 of the display of an image by the display unit 130 will be described with reference to FIG. 19. FIG. 19 is a drawing illustrating an example of an image displayed on the display unit 130. Specifically, FIG. 19 illustrates an image 1800. An input video 1900 of the bridge 1301 imaged by the imaging unit 10 is displayed in the image 1800. Further, in analysis regions 1901, 1902 corresponding to black dots in the input video 1900, the analysis axes are displayed superimposed as arrows rotatable about the black dots. In a case where a direction of a vibration in the analysis region is not displayed in a video on a display unit, the user cannot easily recognize the direction of the vibration in the analysis region. In contrast, in the present embodiment, the analysis axes are displayed superimposed as arrows onto the analysis regions 1901, 1902 in the input video 1900. With the analysis axes thus displayed superimposed onto the analysis regions of the object, the directions of the vibrations in the analysis regions can be easily recognized by the user.

Further, in the image 1800 there are also displayed a graph (analysis region) 1903 of the analysis result of the vibration of the analysis region 1901, and a graph (analysis result) 1904 of the analysis result of the vibration of the analysis region 1902, each analysis result of the vibration being a displacement amount. Therefore, in a case where, for example, the user changes the direction of an analysis axis of at least one of the analysis region 1901 and the analysis region 1902, the changed analysis axis and the graph of the changed analysis result are displayed in conjunction in the image 1800 of the display unit 130. Therefore, the user can easily recognize the analysis result in a case where the analysis axes are configured on a per analysis axis basis.

### Specific Example 2 of Display of Image by Display Unit 130

In specific example 1 described above, the display unit 130 displays one analysis axis per analysis region. However, a plurality of analysis axes may be displayed on the display unit 130, such as a plurality of analysis axes being displayed superimposed onto one analysis region, and the analysis result of the vibration along each of the plurality of analysis axes may be separately displayed on the display unit 130. Below, a specific example 2 of the display of an image by the display unit 130 will be described with reference to FIG. 20.

FIG. 20 is a drawing illustrating an example of an image displayed on the display unit 130. Specifically, (a) of FIG. 20 illustrates an image 2000. An input video 2100 of the bridge 1301 imaged by the imaging unit 10 is displayed in the image 2000. Further, two analysis axes are displayed superimposed as two arrows onto an analysis region 2101 corresponding to the black dot in the input video 2100. (b) of FIG. 20 illustrates an enlarged view near the analysis region 2101, and the two arrows represent an analysis axis 2101a in the up-down direction (Y-axis direction on the input video 2100) and an analysis axis 2101b in a left-right oblique direction. Further, in the image 2000 there are also displayed a graph 1903 of the analysis result of the vibration along the analysis axis 2101a, and a graph 2102 of the analysis result of the vibration along the analysis axis 2101b, each of the analysis results being a displacement amount of the analysis region 2101.

As illustrated in (a) of FIG. 20, the display unit 130 separately displays, on the image 2000, the analysis results of the vibrations respectively corresponding to the plurality of analysis axes 2101a, 2101b displayed superimposed onto the one analysis region 2101. Thus, in a case where a plurality of analysis axes are configured in one analysis region or the like, even when the plurality of analysis axes are displayed on the display unit 130, the analysis results of the respective vibrations can be easily recognized by the user.

Further, the display unit 130 may display a plurality of analysis axes superimposed onto the analysis region 2101 in different colors for each analysis axis. In a case where a plurality of analysis axes are superimposed onto one analysis region, the plurality of analysis axes are displayed in different colors for each analysis axis, making it easy for the user to differentiate the plurality of analysis axes. Further, the display unit 130 may display each graph of an analysis result corresponding to an analysis axis using the color corresponding to the color of the analysis axis. For example, the display unit 130 may display the analysis axis 2101a and the graph 1903 of the analysis result of the vibration along the analysis axis 2101a in a warm color, and the analysis axis 2101b and the graph 2102 of the analysis result of the vibration along the analysis axis 2101b in a cool color. Further, the display unit 130 may display the analysis axis 2101a and the graph 1903 of the analysis result of the vibration along the analysis axis 2101a in monochrome, and the analysis axis 2101b and the graph 2102 of the analysis result of the vibration along the analysis axis 2101b in color. Thus, with each graph of an analysis result corresponding to an analysis axis being displayed in the color corresponding to the color of the analysis axis, the analysis result corresponding to a certain analysis axis can be easily recognized by the user.

Note that while, in the example described above, the display unit 130 displays the analysis axes in two-dimensional directions relative to the analysis region, the present embodiment is not limited thereto. In the present embodiment, the display unit 130 may display analysis axes in a three-dimensional space, such as the x-axis, the y-axis, and the z-axis in FIG. 13, instead of the vertical axis (Y-axis) and the horizontal axis (X-axis) on the input image. In this case, the analysis axis configuration unit 62 may function as the analysis axis configuration unit 72 in the second embodiment and configure the analysis axes in three-dimensional directions. Thus, even in a case where the display unit 130 displays the analysis axes in three-dimensional directions relative to the analysis region, the directions of the vibrations in the analysis region can be easily recognized by the user.

### Effect of Vibration Analysis System 4 According to Fourth Embodiment

As described above, in the vibration analysis system 4 according to the fourth embodiment, the display unit 130 displays the analysis axes superimposed onto a video of an object. This allows the user to easily recognize the direction in which the analysis axis of a certain analysis region is configured. Further, the display unit 130 displays the input video on which the analysis axes are superimposed and the analysis result along the analysis axis simultaneously as an image, making it possible for the user to easily recognize the direction to which a certain analysis result of vibration corresponds.

### Implementation Example by Software

A control block (in particular, the analysis region configuration unit 61, the analysis axis configuration units 62, 72, 82, the vibration analyzing units 63, 73, 83, and the output unit 64) of the vibration analysis devices 60, 70 80 may be realized by a logic circuit (hardware) formed by an integrated circuit (IC chip) or the like, such as an application specific integrated circuit (ASIC) and a field programmable gate array (FPGA), or may be realized by software using a central processing unit (CPU) and a graphics processing unit (GPU).

In the latter configuration, the vibration analysis devices 60, 70, 80 each include a CPU for executing instructions of a vibration analysis program, which is software for realizing each function, a read-only memory (ROM) or a storage device (each of these is referred to as a “recording medium”) in which the vibration analysis program and various types of data are recorded in a computer-readable (or CPU-readable) manner, a random access memory (RAM) in which the vibration analysis program is loaded, and the like. Then, the computer (or CPU) reads the vibration analysis program from the recording medium and executes the vibration analysis program to achieve the object of the present invention. As the recording medium, a “non-transitory tangible medium”, such as a tape, a disk, a card, a semiconductor memory, and a programmable logic circuit, for example, may be used. Further, the vibration analysis program may be supplied to the computer via any transmission medium (communication network, broadcast wave, or the like) capable of transmitting the vibration analysis program. Note that an aspect of the present invention may be realized in a form of a data signal embedded in a carrier wave, which is embodied by electronic transmission of the vibration analysis program.

### Supplement

A vibration analysis device (60, 70, 80) according to a first aspect of the present invention includes an analysis axis configuration unit (62, 72, 82) configured to configure analysis axes (1901, 1902, 2101, 2101a, 2101b) in accordance with an operation of a user, a vibration analyzing unit (63, 73, 83) configured to analyze, based on a video (input videos 300, 301, 302, 1300, 1500, 1600, 1900, 2100) of an object (bridges 303, 1301, automobile 1601), vibration along each of the analysis axes of the object, and an output unit (64) configured to output an analysis result (graphs 1903, 1904, 2102 of the analysis result) obtained by the vibration analyzing unit.

According to the configuration described above, vibration of the object can be suitably analyzed.

In the vibration analysis device according to a second aspect of the present invention, in the above-described first aspect, the vibration analyzing unit may analyze the vibration based on a displacement amount of the object caused by the vibration.

According to the configuration described above, the vibration analyzing unit analyzes the vibration based on the displacement amount of the object, making it possible to obtain an amplitude of the vibration of the object and the like as the analysis result. This makes it possible to more suitably analyze the vibration of the object.

In the vibration analysis device according to a third aspect of the present invention, in the above-described first or second aspect, the vibration analyzing unit may analyze the vibration based on a three-dimensional displacement amount of the object.

According to the configuration described above, a vibration direction, an amplitude, and the like on a three-dimensional space of the object can be analyzed, making it possible to more suitably analyze the vibration of the object.

In the vibration analysis device according to a fourth aspect of the present invention, in the above-described third aspect, the analysis axis configuration unit may configure one of the analysis axes in a direction connecting an imaging unit, configured to capture a video of the object, and the object.

According to the configuration described above, even in a case where one of the analysis axes is configured in a direction connecting the imaging unit and the object, the vibration analyzing unit can suitably analyze the vibration of the object in accordance with distance information, such as three-dimensional positional information, of the object.

In the vibration analysis device according to a fifth aspect of the present invention, in any one of the above-described first to fourth aspects, the analysis axis configuration unit may configure the analysis axes for each of a plurality of areas of the object.

According to the configuration described above, the analysis configuration unit configures the analysis axes for each of a plurality of areas of the object, making it possible to more suitably configure the analysis axes. Therefore, the vibration analyzing unit can more suitably analyze the vibration of the object.

In the vibration analysis device according to a sixth aspect of the present invention, in any one of the above-described first to fifth aspects, the analysis axis configuration unit may configure, among the analysis axes, two analysis axes not orthogonal to each other.

According to the configuration described above, in a case where analysis axes orthogonal to each other are configured and it is difficult to estimate the vibration information of the vibration in a direction along at least one of the analysis axes, the analysis axes can be changed to more suitable directions. With the analysis axes thus changed to suitable directions, the vibration analyzing unit can more suitably analyze the vibration of the object.

In a vibration analysis device according to a seventh aspect of the present invention, in any one of the above-described first to sixth aspects, the vibration analyzing unit may analyze the vibration on a per frequency basis.

According to the configuration described above, even in a case where it is difficult to estimate the vibration information of the vibration in a direction along at least one analysis axis, the analysis axis configuration unit can change the direction of the analysis axis to a suitable direction based on the analysis result obtained by analyzing the vibration on a per frequency basis, and thus the vibration of the object can be more suitably analyzed.

A vibration analysis device according to an eighth aspect of the present invention includes an analysis axis configuration unit configured to configured analysis axes, a vibration analyzing unit configured to analyze, based on a video of an object, vibration along each of the analysis axes of the object, and a display unit (30, 130) configured to display the analysis axes superimposed onto an image of the object and display an analysis result obtained by the vibration analyzing unit.

According to the configuration described above, the vibration of the object can be suitably analyzed. Further, the user can easily recognize the configured direction corresponding to the direction of the vibration of the object.

In the vibration analysis device according to a ninth aspect of the present invention, in the above-described eighth aspect, the analysis axis configuration unit may configure the analysis axes in accordance with a video of the object.

Even in a case where the analysis axes are configured in accordance with a video of the object, the vibration of the object can be suitably analyzed.

In the vibration analysis device according to a tenth aspect of the present invention, in the above-described ninth aspect, the analysis axis configuration unit may configure one of the analysis axes in a direction where an amplitude of the vibration is greater than an amplitude in an array direction of pixels of the video.

According to the configuration described above, the analysis axis is configured in a more suitable direction, making it possible to more suitably analyze the vibration of the object.

In a vibration analysis device according to an eleventh aspect of the present invention, in the above-described ninth or tenth aspect, the analysis axis configuration unit may configure one of the analysis axes in a direction where the amplitude of the vibration is greatest.

According to the configuration described above, the analysis axis is configured in a more suitable direction, making it possible to more suitably analyze the vibration of the object.

In the vibration analysis device according to a twelfth aspect of the present invention, in any one of the above-described eighth to eleventh aspect, the display unit may display a plurality of analysis axes and separately display an analysis result of the vibration along each of the plurality of analysis axes.

According to the configuration described above, even in a case where a plurality of analysis axes are displayed on the display unit, the user can easily recognize the respective analysis results of the vibrations.

A control method for a vibration analysis device according to a thirteenth aspect of the present invention is a control method for a vibration analysis device configured to analyze vibration of an object, the control method including an analysis axis configuration step of configuring analysis axes in accordance with an operation of a user, a vibration analyzing step of analyzing, based on a video of the object, the vibration along each of the analysis axes of the object, and an output step of outputting an analysis result of the vibration analyzing step.

According to the configuration described above, effects similar to those of the vibration analysis device according to an aspect of the present invention are produced.

According to the configuration described above, effects similar to those of the vibration analysis device according to an aspect of the present invention are produced.

Furthermore, the vibration analysis device according to each of the aspects of the present invention may be implemented by a computer. In this case, a vibration analysis program of the vibration analysis device that causes the computer to function as each unit (software element) included in the vibration analysis device to implement the vibration analysis device by the computer, and a computer-readable recording medium having recorded therein the vibration analysis program fall within the scope of the present invention.

### Supplementary Information

The present invention is not limited to each of the above-described embodiments. It is possible to make various modifications within the scope of the claims. An embodiment obtained by appropriately combining technical elements each disclosed in different embodiments falls also within the technical scope of the present invention. Furthermore, technical elements disclosed in the respective embodiments may be combined to provide a new technical feature.

For example, the technical means disclosed in the third embodiment is implemented in accordance with an input image, and the technical means disclosed in the fourth embodiment is implemented in accordance with an operation of the user, and thus these technical means cannot be combined as is. However, using known technical means such as a switch button (not illustrated), it is possible to switch between the technical means disclosed in the third embodiment and the technical means disclosed in the fourth embodiment. Accordingly, each of the technical means disclosed in the first to fourth embodiments can be optionally combined by using known technical means, such as a switch button, and such technical means also fall within the technical scope of the present invention.

1. A vibration analysis device comprising:
an analysis axis configuration unit configured to configure analysis axes in accordance with an operation of a user;
a vibration analyzing unit configured to analyze, based on a video of an object, vibration along each of the analysis axes of the object; and
an output unit configured to output an analysis result obtained by the vibration analyzing unit.

2. The vibration analysis device according to claim 1,
wherein the vibration analyzing unit analyzes the vibration based on a displacement amount of the object caused by the vibration.

3. The vibration analysis device according to claim 1,
wherein the vibration analyzing unit analyzes the vibration based on a three-dimensional displacement amount of the object.

4. The vibration analysis device according to claim 3,
wherein the analysis axis configuration unit configures one of the analysis axes in a direction connecting an imaging unit, configured to capture a video of the object, and the object.

5. The vibration analysis device according to claim 1,
wherein the analysis axis configuration unit configures the analysis axes for each of a plurality of areas of the object.

6. The vibration analysis device according to claim 1,
wherein the analysis axis configuration unit configures, among the analysis axes, two analysis axes not orthogonal to each other.

7. The vibration analysis device according to claim 1,
wherein the vibration analyzing unit analyzes the vibration on a per frequency basis.

8. A vibration analysis device comprising:
an analysis axis configuration unit configured to configure analysis axes;
a vibration analyzing unit configured to analyze, based on a video of an object, vibration along each of the analysis axes of the object; and
a display unit configured to display the analysis axes superimposed onto an image of the object and display an analysis result obtained by the vibration analyzing unit.

9. The vibration analysis device according to claim 8,
wherein the analysis axis configuration unit configures the analysis axes in accordance with a video of the object.

10. The vibration analysis device according to claim 9,
wherein the analysis axis configuration unit configures one of the analysis axes in a direction where an amplitude of the vibration is greater than an amplitude in an array direction of pixels of the video.

11. The vibration analysis device according to claim 9,
wherein the analysis axis configuration unit configures one of the analysis axes in a direction where an amplitude of the vibration is greatest.

12. The vibration analysis device according to claim 8,
wherein the display unit displays a plurality of analysis axes and separately display an analysis result of the vibration along each of the plurality of analysis axes.

13. A control method for a vibration analysis device configured to analyze vibration of an object, the control method comprising:
an analysis axis configuration step of configuring analysis axes in accordance with an operation of a user;
a vibration analyzing step of analyzing, based on a video of the object, the vibration along each of the analysis axes of the object; and
an output step of outputting an analysis result of the vibration analyzing step.

14. non-transitory computer-readable recording medium storing a program configured to cause a computer to function as the vibration analysis device of claim 1,
wherein the computer is caused to function as the analysis axis configuration unit, the vibration analyzing unit, and the output unit.

15. (canceled)
